(19) United States
(12) Patent Application Publication
(10) Pub. No.: US 2012/0009914 A1
(43) Pub. Date: Jan. 12, 2012

(54) ELECTRONIC DEVICE CONTROLLING APPARATUS FOR MOBILE TERMINAL AND METHOD THEREOF

(75) Inventors: Kyechul LEE, Seoul (KR); Jinwon CHOI, Suwon-Si (KR)

(73) Assignee: LG ELECTRONICS INC., Seoul (KR)

(21) Appl. No.: 13/178,359

(22) Filed: Jul. 7, 2011

(30) Foreign Application Priority Data
Jul. 8, 2010 (KR) 10-2010-0066018

(51) Int. Cl. H04W 4/02

(52) U.S. Cl. 455/420

(57) ABSTRACT

An electronic device controlling apparatus for a mobile terminal capable of conveniently and effectively remote-control an electronic device by using a mobile terminal without a remote controller of the electronic device, and a method thereof. When an electronic device is displayed on a display unit through a camera, an electronic device identifier is received from the electronic device through a communication module. And, the electronic device is controlled based on electronic device information matching with the received electronic device identifier.

### CROSS-REFERENCE TO RELATED APPLICATION

Pursuant to 35 U.S.C. §119(a), this application claims the benefit of earlier filing date and right of priority to Korean Application No. 10-2010-0066018, filed on Jul. 8, 2010, the contents of which is incorporated by reference herein in its entirety.

### BACKGROUND OF THE INVENTION

1. Field of the Invention

This specification relates to an electronic device controlling apparatus for a mobile terminal and a method thereof.

2. Background of the Invention

Generally, the conventional electronic device controlling apparatus serves to control a corresponding electronic device such as a television through a communication module. The apparatus displays, on a display unit, a list of electronic devices manufactured from various companies. Once a user selects a specific electronic device from the list, the apparatus controls the selected electronic device.

### SUMMARY OF THE INVENTION

To achieve these and other advantages and in accordance with the purpose of this specification, as embodied and broadly described herein, there is provided an electronic device controlling apparatus for a mobile terminal, the apparatus comprising: a camera; a communication module; and a controller configured to receive, through the communication module, an electronic device identifier from an electronic device displayed on a display unit through the camera, and configured to control the electronic device through the communication module based on electronic device information matching with the received electronic device identifier.

The controller may request an electronic device identifier, from the electronic device displayed on the display unit.

The controller may receive the electronic device information matching with the received electronic device identifier, from a server, through a communication network.

The controller may read the electronic device information matching with the received electronic device identifier, from a storage unit.

The electronic device identifier may include one of a product number, a serial number and a model name of the electronic device.

The controller may request, from the electronic device, the electronic device identifier, through an infrared ray communication module inside the communication module. And, the controller may receive the electronic device identifier from an infrared ray communication module of the electronic device.

The electronic device information may include remote controller information for remote-controlling the electronic device, and/or a manual of the electronic device.

The electronic device information may further include an image of a remote controller which remote-controls the electronic device.

The controller may display the image of the remote controller on the display unit, and may activate keys inside the image based on the remote controller information.

The controller may operate the camera when an electronic device control menu or an electronic device control icon displayed on the display unit is selected.

The controller may recognize the electronic device from an image displayed on the display unit through the camera, and may display, on the display unit, a remote controller menu for controlling the recognized electronic device.

The remote controller menu may include an image of a remote controller which remote-controls the electronic device, and keys of the remote controller.

According to another aspect of the present invention, there is provided an electronic device controlling apparatus for a mobile terminal, the apparatus comprising: a camera; a communication module; and a controller configured to transmit, through the communication module, to a server, an electronic device image displayed on a display unit through the camera, and configured to control the electronic device through the communication module based on electronic device information matching with the electronic device image received from the server, wherein the electronic device information includes a manual of the electronic device and/or a remote controller menu of the electronic device, and wherein the remote controller menu comprises an image of a remote controller which remote-controls the electronic device, and keys of the remote controller.

To achieve these and other advantages and in accordance with the purpose of this specification, as embodied and broadly described herein, there is also provided a method for controlling an electronic device for a mobile terminal, the method comprising: receiving an electronic device identifier through a communication module, from an electronic device displayed on a display unit through a camera; and controlling the electronic device through the communication module based on electronic device information matching with the received electronic device identifier.

According to another aspect of the present invention, there is provided a method for controlling an electronic device for a mobile terminal, the method comprising: transmitting, through a communication module, to a server, an electronic device image displayed on a display unit through a camera; and controlling the electronic device through the communication module based on electronic device information matching with the electronic device image received from the server, wherein the electronic device information includes a manual of the electronic device and/or a remote controller menu of the electronic device, and wherein the remote controller menu comprises an image of a remote controller which remote-controls the electronic device, and keys of the remote controller.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram showing a configuration of a mobile terminal to which an electronic device controlling apparatus according to an embodiment of the present invention has been applied;

FIG. 2 is a view showing a configuration of an electronic device controlling apparatus for a mobile terminal according to a first embodiment of the present invention;

FIG. 3 is a flowchart showing an electronic device controlling method for a mobile terminal according to the first embodiment of the present invention;

FIG. 4 is an exemplary view showing an electronic device displayed on a display unit of an electronic device controlling apparatus according to the first embodiment of the present invention;

FIG. 5 is an exemplary view showing an image (including keys) of a remote controller, the image displayed on a display unit of an electronic device controlling apparatus according to the first embodiment of the present invention;

FIG. 6 is a flowchart showing an electronic device controlling method for a mobile terminal according to a second embodiment of the present invention; and

FIG. 7 is a flowchart showing an electronic device controlling method for a mobile terminal according to a third embodiment of the present invention.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

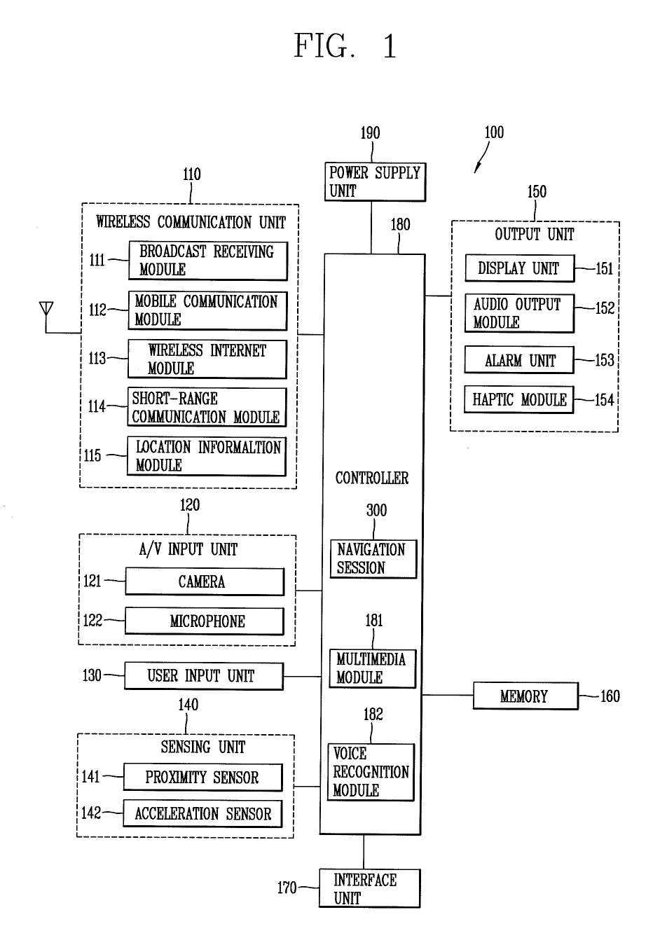

Hereinafter, with reference to FIGS. 1 to 7, an electronic device controlling apparatus for a mobile terminal and a method thereof is discussed. The apparatus is capable of conveniently and effectively remote-controlling an electronic device by using a mobile terminal without a remote controller of the electronic device.

FIG. 1 is a block diagram according to an embodiment showing a configuration of a mobile terminal 100 to which an electronic device controlling apparatus of the present invention has been applied. The mobile terminal (mobile communication terminal) 100 may be implemented in a various forms such as mobile phones, smart phones, notebook computers, digital broadcast terminals, PDAs (Personal Digital Assistants), PMPs (Portable Multimedia Player), etc.

As shown in FIG. 1, the mobile terminal 100 includes a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal 100 having various components, but it is understood that implementing all of the illustrated components is not a requirement. The mobile terminal 100 may be implemented by greater or fewer components.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast associated information may refer to information associated with a broadcast channel, a broadcast program or a broadcast service provider. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal (when the mobile terminal is located in a vehicle, the location of the vehicle can be checked). For example, the location information module 115 may be embodied by using a GPS (Global Positioning System) module that receives location information from a plurality of satellites. Here, the location information may include coordinate information represented by latitude and longitude values. For example, the GPS module may measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. As the location information module 115, a Wi-Fi position system and/or a hybrid positioning system may be used.

The A/V input unit 120 is configured to receive an audio or video signal. The A/V input unit 120 may include a camera 121 (or other image capture device) and a microphone 122 (or other sound pick-up device). The camera 121 processes image data of still pictures or video obtained according to a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The interface unit 170 (or other connection means) serves as an interface by which at least one external device may be connected with the mobile terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. Here, the identification module may be a memory chip (or other element with memory or storage capabilities) that stores various information for authenticating user's authority for using the mobile terminal 100 and may include a user identity module (UIM), a subscriber identity module (SIM) a universal subscriber identity module (USIM), and the like. In addition, the device having the identification module (referred to as the ‘identifying device’, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile terminal 100 or may be used to transfer data within the mobile terminal to an external device.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, a haptic module 154, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. The mobile terminal 100 may include two or more display units (or other display means) according to its particular desired embodiment. For example, the mobile terminal may include both an external display unit (not shown) and an internal display unit (not shown).

When the display unit 151 and the touch pad are overlaid in a layered manner to form a touch screen, the display unit 151 may function as both an input device and an output device. The touch sensor may have the form of, for example, a touch film, a touch sheet, a touch pad, and the like.

The touch sensor may be configured to convert the pressure applied to a particular portion of the display unit 151 or a change in capacitance generated at a particular portion of the display unit 151 into an electrical input signal. The touch sensor may be configured to detect a touch input pressure as well as a touch input position and a touch input area. When there is a touch input with respect to the touch sensor, the corresponding signal(s) are sent to a touch controller (not shown). The touch controller processes the signal(s) and transmits corresponding data to the controller 180. Accordingly, the controller 180 can recognize a touched region of the display unit 151.

Proximity touch in the present exemplary embodiment refers to recognition of the pointer positioned to be close to the touch screen without being in contact with the touch screen.

A proximity sensor 141 may be may be disposed within the mobile terminal covered by the touch screen or near the touch screen. The proximity sensor 141 refers to a sensor for detecting the presence or absence of an object that accesses a certain detect surface or an object that exists nearby by using the force of electromagnetism or infrared rays without a mechanical contact. Thus, the proximity sensor 141 has a longer life span compared with a contact type sensor, and it can be utilized for various purposes.

The example of the proximity sensor 141 may be a transmission type photo sensor, a direct reflection type photo sensor, a mirror-reflection type photo sensor, an RF oscillation type proximity sensor, a capacitance type proximity sensor, a magnetic proximity sensor, an infrared proximity sensor. When the touch screen is an electrostatic type touch screen, an approach of the pointer is detected based on a change in an electric field according to the approach of the pointer. In this case, the touch screen (touch sensor) may be classified as a proximity sensor.

In the following description, for the sake of brevity, recognition of the pointer positioned to be close to the touch screen without being contacted will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

The proximity sensor 141 detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The sensing unit 140 may include an acceleration sensor 142. The acceleration sensor 142, an element for converting a change in acceleration in one direction into an electrical signal, is widely used in line with the development of a micro-electromechanical system (MEMS) technique. The acceleration sensor 142 includes various types of sensors: an acceleration sensor installed in an air-bag system of a vehicle to measure a great value of acceleration used for detecting a collision, an acceleration sensor for recognizing a fine operation of a user's hand so as to be used as an input unit for games, or the like. The acceleration sensor 142 is configured such that two axes or three axes are mounted on a single package, and only a Z axis may be required according to a usage environment. Thus, when an X-axis directional acceleration sensor or a Y-axis directional acceleration sensor is to be used for a certain reason, a separate piece substrate may be used and the acceleration sensor may be mounted on a main substrate.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed in the mobile terminal 100. The audio output module 152 may include a receiver, a speaker, a buzzer, etc.

The alarm unit 153 outputs a signal for informing about an occurrence of an event of the mobile terminal 100. Events generated in the mobile terminal may include call signal reception, message reception, key signal inputs, and the like. In addition to video or audio signals, the alarm unit 153 may output signals in a different manner, for example, to inform about an occurrence of an event. For example, the alarm unit 153 may output a signal in the form of vibration. When a call signal is received or a message is received, the alarm unit 153 may vibrate the mobile terminal through a vibration means. Or, when a key signal is inputted, the alarm unit 153 may vibrate the mobile terminal 100 through a vibration means as a feedback with respect to the key signal input. Through the vibration, the user may recognize the occurrence of an event. A signal for notifying about the occurrence of an event may be output to the display unit 151 or to the voice output module 152.

The haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100. The haptic module 154 may be provided to a place which is frequently in contact with the user. For example, the haptic module 154 may be provided to a steering wheel, a gearshift, a lever, a seat, and the like.

The memory 160 may store software programs used for the processing and controlling operations performed by the controller 180, or may temporarily store data (e.g., a map data, phonebook, messages, still images, video, etc.) that are inputted or outputted.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like. Here, the identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port. The interface unit 170 may be used to receive inputs (e.g., data, information, power, etc.) from an external device and transfer the received inputs to one or more elements within the mobile terminal 100 or may be used to transfer data between the mobile terminal and an external device.

When the mobile terminal 100 is connected with an external cradle, the interface unit 170 may serve as a passage to allow power from the cradle to be supplied there through to the mobile terminal 100 or may serve as a passage to allow various command signals inputted by the user from the cradle to be transferred to the mobile terminal there through. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself. For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

The voice recognition module 182 recognizes a voice pronounced by the user and performs a corresponding function according to the recognized voice signal.

A navigation session 300 applied to the mobile terminal 100 serves to generate road guide information based on map data and current position information, and to inform the generated road guide information to a user.

An electronic device controlling apparatus applied to the mobile terminal 100 according to the present invention comprises a camera 121, a wireless communication unit 110, and a controller 180 configured to request an electronic device identifier through the wireless communication module 110, from an electronic device displayed on the display unit 151 through the camera 121 (or an electronic device focused by the camera 121), configured to receive the electronic device identifier from the electronic device, configured to recognize the received electronic device identifier, configured to receive, from a server, through a communication network, electronic device information matching with the recognized electronic device identifier, and configured to control the electronic device through the wireless communication unit 110 based on the received electronic device information. The electronic device identifier may include a product number, a serial number, a model name, and so on.

The electronic device information may include remote control information (or remote controller information) for remote-controlling the electronic device, and/or a manual (product manual) of the electronic device. For instance, when the electronic device is a television (such as a digital TV or a 3-D TV), the electronic device information may include remote controller information including channel information, volume information, setting information, additional information of the television, and so on.

The remote controller information may further include the same image as a substantial remote controller of the electronic device. For instance, the controller 180 displays, on the display unit 151, a remote controller image included in the remote controller information. Then, the controller 180 activates keys (or buttons) of the remote controller image displayed on the display unit 151 based on the remote controller information. Accordingly, a user may remotely control the electronic device by selecting a desired key (or button) of the remote controller image displayed on the display unit 151.

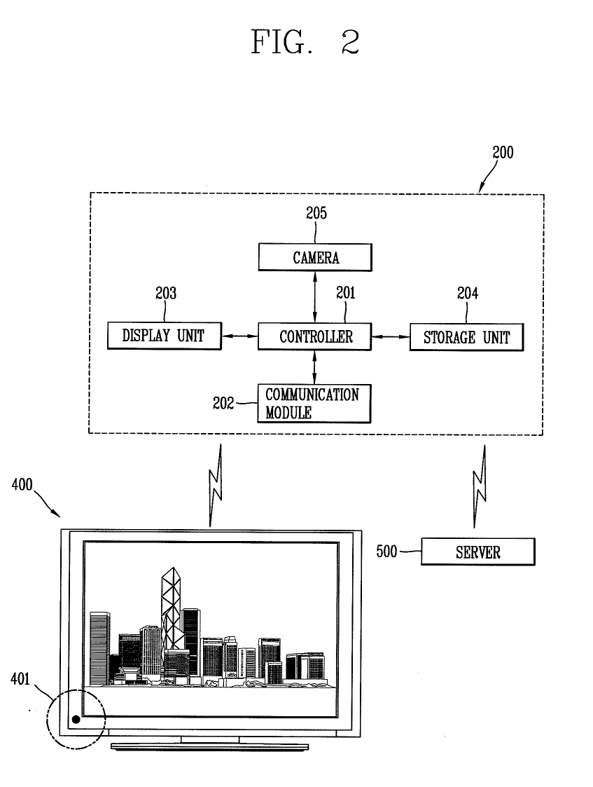

Hereinafter, an electronic device controlling apparatus and a method thereof according to a first embodiment of the present invention will be explained with reference to FIGS. 2 to 5.

The electronic device controlling apparatus and the method thereof according to a first embodiment of the present invention may be applied not only to a mobile communication terminal such as the mobile terminal 100, a portable phone, a telematics terminal and a navigation apparatus, but also to a mobile communication terminal such as a smart phone, a notebook computer, personal digital assistants (PDA) and a portable multimedia player (PMP).

FIG. 2 is a view showing a configuration of an electronic device controlling apparatus for a mobile terminal according to a first embodiment of the present invention.

As shown in FIG. 2, the electronic device controlling apparatus according to the first embodiment of the present invention comprises a camera 205, a communication module 202, and a controller 201. The controller 201 is configured to request an electronic device identifier through the communication module 202, from an electronic device 400 displayed on a display unit 203 through the camera 205 (or an electronic device 400 focused by the camera 205). The controller 201 is also configured to receive the electronic device identifier from the electronic device 400, configured to recognize the received electronic device identifier. The controller 201 is also configured to receive, from a server 500, through a communication network, electronic device information matching with the recognized electronic device identifier. The controller 201 is also configured to control the electronic device 400 through the communication module 202 based on the received electronic device information. The electronic device identifier may include a product number, a serial number, a model name, and so on.

The electronic device information may include remote control information (remote controller information) for remote-controlling the electronic device, and/or a manual (product manual) of the electronic device. For instance, when the electronic device is a television, the electronic device information may include remote controller information including channel information, volume information, setting information, additional information of the television, and so on.

The remote controller information may further include the same image as a substantial remote controller of the electronic device. For instance, the controller 201 displays, on the display unit 203, a remote controller image included in the remote controller information. Then, the controller 201 activates keys (or buttons) of the remote controller image displayed on the display unit 203 based on the remote controller information. Accordingly, a user may remotely control the electronic device 400 by selecting a desired key (or button) of the remote controller image displayed on the display unit 203.

The communication module 202 may include a broadcasting reception module, a mobile communication module, a wireless internet module, a short-range communication module, a position information module, and so on. And, the short-range communication module may include a Bluetooth module, an RFID (Radio Frequency Identification) module, an IrDA (Infrared Data Association) module, a UWB (Ultra Wideband) module, a ZigBee module, and so on.

The controller 201 may read the electronic device information matching with the recognized electronic device identifier, not only from the server 500, but also from a storage unit 204. Then, the controller 201 may control the electronic device 400 through the communication module 202 based on the read electronic device information.

The electronic device controlling apparatus for a mobile terminal according to the present invention is capable of conveniently and effectively remote-control an electronic device by using a mobile terminal without a remote controller of the electronic device when the electronic device is displayed on the display unit 203 through the camera, based on electronic device information matching with an electronic device identifier received from the electronic device.

Hereinafter, a method for controlling an electronic device according to the first embodiment of the present invention will be explained with reference to FIGS. 2 to 5.

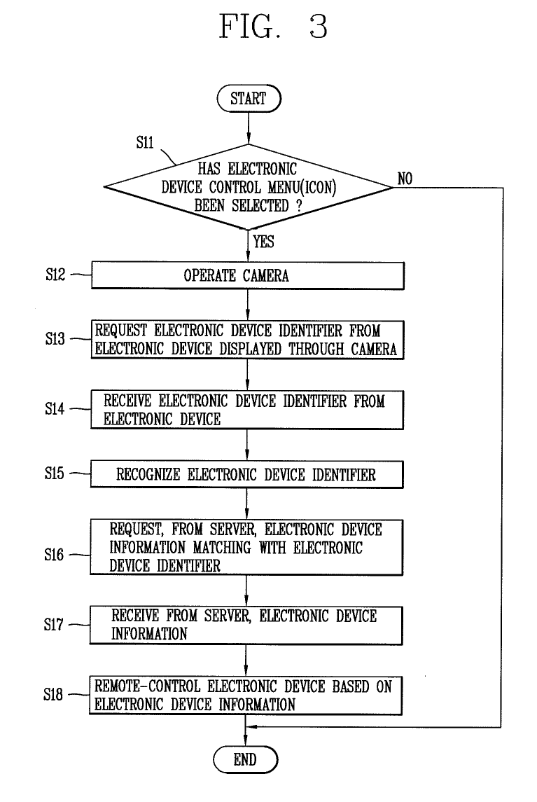

FIG. 3 is a flowchart showing an electronic device controlling method for a mobile terminal according to the first embodiment of the present invention. The method of FIG. 3 can be implemented in the devices of FIGS. 1 and 2.

Firstly, the controller 201 checks whether an electronic device control menu or an electronic device control icon displayed on the display unit 203 has been selected by a user (S11).

If an electronic device control menu or an electronic device control icon displayed on the display unit 203 has been selected by a user as a result of the check (S11), the controller 201 operates the camera 205 (S12).

When an electronic device 400 (e.g., a television, a media player, an air conditioner, etc.) is displayed on the display unit 203 through the camera 205, the controller 201 requests the electronic device identifier from the electronic device 400 through the communication module 202 (S13).

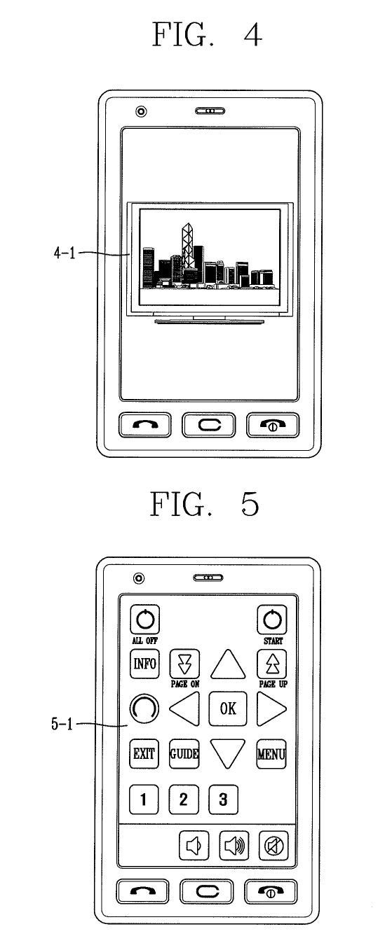

FIG. 4 is an exemplary view showing an electronic device displayed on the display unit of an electronic device controlling apparatus according to the first embodiment of the present invention.

As shown in FIG. 4, when an electronic device 4-1 is displayed on the display unit 203 through the camera 205, the controller 201 transmits, to an infrared ray module 401 of the electronic device 400, a message requesting the electronic device identifier, through an infrared ray module inside the communication module 202. The infrared ray module 401 of the electronic device 400 includes an infrared ray receiver and an infrared ray transmitter. Here, the electronic device 400 transmits the electronic device identifier, to the communication module 202 through the infrared ray module 401, based on the message requesting the electronic device identifier, the message received from the infrared ray module 401. The electronic device may be a television, a media player (e.g., a blue-ray or other compact disc player), etc., and the electronic device identifier may be a product number, a serial number, a model name, etc. of a television, a media player (e.g., a blue-ray or other compact disc player), etc.

The communication module 202 receives the electronic device identifier from the electronic device 400 (S14), and outputs the received electronic device identifier to the controller 201.

The controller 201 recognizes the electronic device identifier output from the communication module 202 (S15), and requests electronic device information matching with the recognized electronic device identifier, from the server 500, through a communication network (S16).

The server 500 searches, from a database, electronic device information matching with the electronic device identifier, and transmits the searched electronic device information to the communication module 202 through the communication network. The electronic device information indicates information for remote-controlling the electronic device (e.g., a television, a media player, an air conditioner, etc.). When the electronic device is implemented as a media player, the electronic device information may include channel information, volume information, setting information, additional information of the media player, and so on. Here, the remote controller information may further include the same image as a substantial remote controller of the electronic device.

The communication module 202 receives the electronic device information from the server 500 (S17), and outputs the received electronic device information to the controller 201.

The controller 201 remote-controls the electronic device 400 based on the electronic device information output from the communication module 202 (S18). For instance, the controller 201 displays, on the display unit 203, a remote controller image included in the remote controller information. Then, the controller 201 activates keys (or buttons) of the remote controller image displayed on the display unit 203 based on remote controller information inside the electronic device. Accordingly, a user may remotely control the electronic device 400 by selecting a desired key (or button) of the remote controller image displayed on the display unit 203.

FIG. 5 is an exemplary view showing an image (including keys) of a remote controller, the image displayed on a display unit of an electronic device controlling apparatus according to the first embodiment of the present invention.

As shown in FIG. 5, the controller 201 displays, on the display unit 203, a remote controller image 5-1 included in the remote controller information. Then, the controller 201 activates keys (or buttons or other input devices) of the remote controller image 5-1 displayed on the display unit 203 based on remote controller information (e.g., button values or key values) inside the electronic device 400. Accordingly, the user may remotely control the electronic device 400 by selecting a desired key (or button or predetermined area) of the remote controller image displayed on the display unit 203. The method for controlling the electronic device 400 through the communication module (e.g., the infrared ray communication module 401) by selecting a button (or key) has been already disclosed, and thus detailed explanations thereof will be omitted.

The electronic device controlling apparatus for a mobile terminal according to the first embodiment of the present invention is capable of conveniently and effectively remote-control an electronic device by using a mobile terminal without a remote controller of the electronic device when the electronic device is displayed on the display unit 203 through the camera, based on electronic device information matching with the electronic device identifier received from the electronic device.

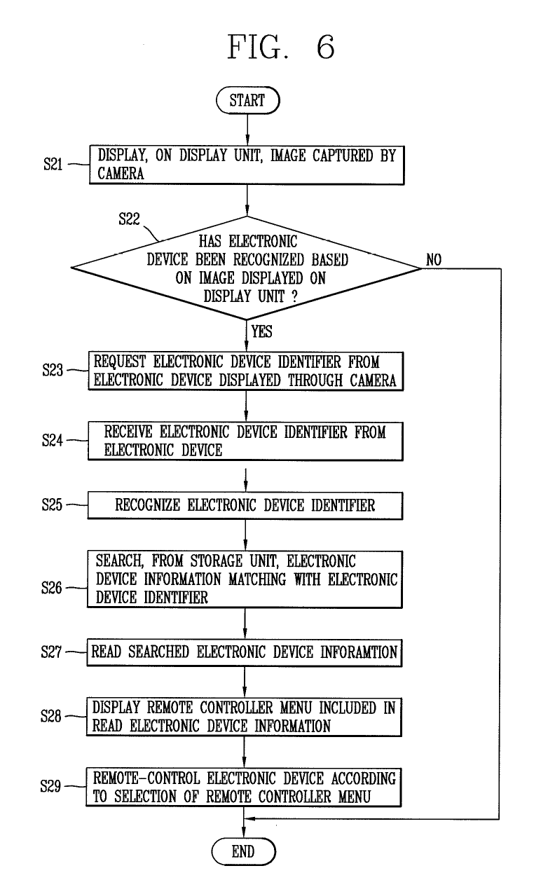

Hereinafter, an electronic device controlling apparatus for a mobile terminal and a method thereof according to a second embodiment of the present invention will be explained with reference to FIGS. 2 and 6. The electronic device controlling apparatus and the method thereof according to the second embodiment of the present invention may be applied not only to a mobile communication terminal such as the mobile terminal 100, a telematics terminal and a navigation apparatus, but also to a mobile communication terminal such as a smart phone, a notebook computer, personal digital assistants (PDA) and a portable multimedia player (PMP).

FIG. 6 is a flowchart showing an electronic device controlling method for a mobile terminal according to the second embodiment of the present invention. The method of FIG. 6 may be implemented in the devices of FIGS. 1 and 2.

Firstly, the controller 201 displays, on the display unit 203, an image captured by the camera 205 (S21).

Then, the controller 201 checks whether an electronic device has been recognized, based on the image displayed on the display unit 203 (S22). For instance, the controller 201 analyzes features of an image displayed on the display unit 203 through the camera 205. Then, the controller 201 searches for images having something in common with the displayed image, among electronic device images pre-stored in the storage unit 204, thereby recognizing an electronic device image based on the displayed image.

When an electronic device is recognized based on the displayed image, the controller 201 requests an electronic device identifier from the electronic device 400 through the communication module 202 (S23). For instance, when an electronic device is recognized based on the displayed image, the controller 201 transmits a message requesting the electronic device identifier, to the infrared ray module 401 of the electronic device 400, through an infrared ray module inside the communication module 202. The infrared ray module 401 of the electronic device 400 includes an infrared ray receiver and an infrared ray transmitter. Here, the electronic device 400 transmits the electronic device identifier, to the communication module 202 through the infrared ray module 401, based on the message requesting the electronic device identifier, the message received through the infrared ray module 401.

The communication module 202 receives the electronic device identifier from the electronic device 400 (S24), and outputs the received electronic device identifier to the controller 201.

The controller 201 recognizes the electronic device identifier output from the communication module 202 (S25), and searches for electronic device information matching with the recognized electronic device identifier, from the storage unit 204 (S26). The electronic device information is pre-stored in the storage unit 204. The electronic device information includes an electronic device manual and/or a remote controller menu for remote-controlling the electronic device (e.g., a television, a media player, an air conditioner, etc.). The remote controller menu includes an image of a remote controller which remote-controls the electronic device, and keys of the remote controller. For instance, when the electronic device is implemented as a media player, the keys of the remote controller include keys for controlling channel information, volume information, setting information, additional information of the media player, and so on.

The controller 201 reads the electronic device information searched from the storage unit 204 (S27), and displays, on the display unit 203, a remote controller menu (remote controller menu corresponding to the electronic device) included in the read electronic device information (S28). The remote controller menu displayed on the display unit 203 includes a remote controller image and buttons (keys, code values corresponding to keys). Here, the buttons (keys) are activated based on channel information, volume information, setting information, additional information, and so on.

The controller 201 controls the electronic device through the communication module (e.g., infrared ray communication module) according to a menu selected from the remote controller menu by the user (S29).

In the second embodiment of the present invention, an electronic device is recognized based on an image displayed on the display unit 203 through the camera, and a remote controller menu for controlling the recognized electronic device is displayed on the display unit 203. This may allow the user to rapidly and easily select a remote controller menu of the corresponding electronic device through the camera.

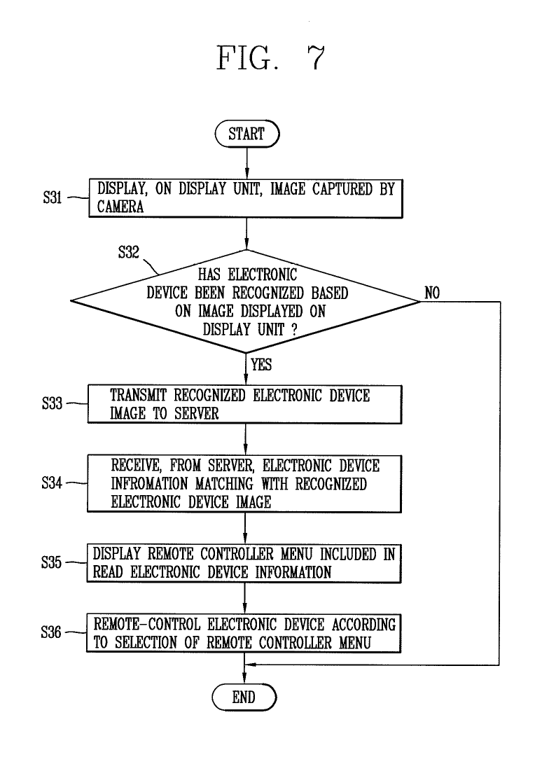

Hereinafter, an electronic device controlling apparatus for a mobile terminal and a method thereof according to a third embodiment of the present invention will be explained with reference to FIGS. 2 and 7. The electronic device controlling apparatus and the method thereof according to the third embodiment of the present invention may be applied not only to a mobile communication terminal such as the mobile terminal 100, a telematics terminal and a navigation apparatus, but also to a mobile communication terminal such as a smart phone, a notebook computer, personal digital assistants (PDA) and a portable multimedia player (PMP).

FIG. 7 is a flowchart showing an electronic device controlling method for a mobile terminal according to the third embodiment of the present invention. The method of FIG. 7 may be implemented in the devices of FIGS. 1 and 2.

Firstly, the controller 201 displays, on the display unit 203, an image captured by the camera 205 (S31).

Then, the controller 201 checks whether an electronic device has been recognized based on the image displayed on the display unit 203 (S32). For instance, the controller 201 analyzes features of an image displayed on the display unit 203 through the camera 205. Then, the controller 201 searches for images having something in common with the displayed image, among electronic device images pre-stored in the storage unit 204, thereby recognizing an electronic device image based on the displayed image.

When an electronic device has been recognized based on the displayed image, the controller 201 transmits the recognized electronic device image to the server 500 through the communication module 202 (S33). Here, the controller 201 may transmit an entire image including the recognized electronic device and a background to the server 500, or may transmit only an image corresponding to the recognized electronic device to the server 500.

The server 500 searches, from a database, electronic device information matching with the recognized electronic device. Then, the server 500 transmits the searched electronic device information to the controller 201 through the communication module 202. The electronic device information includes an electronic device manual and/or a remote controller menu for remote-controlling the electronic device (e.g., a television, a media player, an air conditioner, etc.). The remote controller menu includes an image of a remote controller which remote-controls the electronic device, and keys of the remote controller. For instance, when the electronic device is implemented as a media player, the keys of the remote controller include keys for controlling channel information, volume information, setting information, additional information of the media player, and so on.

The controller 201 receives the electronic device information matching with the recognized electronic device image (S34).

The controller 201 displays, on the display unit 203, a remote controller menu (remote controller menu corresponding to the electronic device) included in the received electronic device information (S35). The remote controller menu displayed on the display unit 203 includes a remote controller image and buttons (keys, code values corresponding to keys). Here, the buttons (keys) are activated based on channel information, volume information, setting information, additional information, and so on.

The controller 201 controls the electronic device through the communication module (e.g., infrared ray communication module) according to a menu selected from the remote controller menu by a user (S36).

In the third embodiment of the present invention, an electronic device is recognized based on an image displayed on the display unit 203 through the camera, and the recognized electronic device image is transmitted to the server. Then, electronic device information matching with the electronic device image is received from the server. This may allow a remote controller menu to be displayed as the user merely captures a corresponding electronic device through the camera.

As aforementioned, in the embodiments of the present invention, the electronic device controlling apparatus for a mobile terminal according to the present invention is capable of conveniently and effectively remote-control an electronic device by using a mobile terminal without a remote controller of the electronic device when the electronic device is displayed on the display unit through the camera, based on electronic device information matching with an electronic device identifier received from the electronic device.

In the embodiments of the present invention, an electronic device is recognized based on an image displayed on the display unit through the camera, and a remote controller menu for controlling the recognized electronic device is displayed on the display unit. This may allow a user to rapidly and easily select the remote controller menu of the corresponding electronic device through the camera.

In the embodiments of the present invention, an electronic device is recognized based on an image displayed on the display unit through the camera, and the recognized electronic device image is transmitted to the server. Then, electronic device information matching with the electronic device image is received from the server. This allows the remote controller menu to be displayed on the display unit as a user merely captures the corresponding electronic device through the camera.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a camera;
a memory;
a display unit;
a wireless communication module; and
a controller operatively connected to the camera, the memory, the display unit, and the wireless communication module, the controller configured to
determine an identifier of an electronic device that has been or is currently viewed by the camera,
send the identifier to one of the memory and a remote server connected to the wireless communication module,
receive electronic device information corresponding to the identifier from the one of the memory and the remote server, and
control the electronic device based on the received electronic device information.

2. The mobile terminal of claim 1, wherein the controller is configured to determine the identifier by wirelessly receiving the identifier from the electronic device in response to a request wirelessly transmitted from the mobile terminal to the electronic device.

3. The mobile terminal of claim 1, wherein the identifier of the electronic device comprises one of a product number, a serial number and a model name of the electronic device.

4. The mobile terminal of claim 1, wherein the electronic device information comprises a displayable user manual of the electronic device or a displayable user data of the electronic device.

5. The mobile terminal of claim 1, wherein the electronic device information comprises remote controller information for remote-controlling the electronic device via the mobile terminal.

6. The mobile terminal of claim 5, wherein the electronic device information further comprises image data corresponding to the remote controller information.

7. The mobile terminal of claim 6, wherein the controller is configured to
display an image of a remote controller on the display unit based on the image data, and
remote-control the electronic device via the displayed image of the remote controller.

8. The mobile terminal of claim 1, wherein the controller is configured to display one of an electronic device control menu and an electronic device control icon each configured to enable a user to command the mobile terminal to determine the identifier of the electronic device.

9. The mobile terminal of claim 1, wherein the controller is configured to determine the identifier based on a matching of an image of the electronic device captured by the camera to an image or other data stored in the one of the memory and the remote server.

10. The mobile terminal of claim 9, wherein the controller is configured to receive the identifier from the electronic device in response to a request wirelessly transmitted from the mobile terminal to the electronic device after the matching of the image of the electronic device captured by the camera to the image or other data stored in the one of the memory and the remote server.

11. A method for controlling an electronic device with a mobile terminal, the method comprising:
determining, by the mobile terminal, an identifier of the electronic device that has been or is currently viewed by a camera associated with the mobile terminal;
sending, by the mobile terminal, the identifier to one of a memory associated with the mobile terminal and a remote server wirelessly connected to the mobile terminal;
receiving, by the mobile terminal, electronic device information corresponding to the identifier from the one of the memory and the remote server; and
controlling, by the mobile terminal, the electronic device based on the received electronic device information.

12. The method of claim 11, further comprising:
wirelessly receiving, by the mobile terminal, the identifier from the electronic device in response to a request wirelessly transmitted from the mobile terminal to the electronic device.

13. The method of claim 11, wherein the identifier of the electronic device comprises one of a product number, a serial number and a model name of the electronic device.

14. The method of claim 11, wherein the electronic device information comprises a displayable user manual or a displayable user data.

15. The method of claim 11, wherein the electronic device information comprises remote controller information for remote-controlling the electronic device via the mobile terminal.

16. The method of claim 15, wherein the electronic device information further comprises image data corresponding to the remote controller information.

17. The method of claim 16, further comprising:
displaying an image of a remote controller on a display unit of the mobile terminal based on the image data; and
remote-controlling, by the mobile terminal, the electronic device via the displayed image of the remote controller.

18. The method of claim 11, wherein the step of determining comprises:
displaying, by the mobile terminal, one of an electronic device control menu and an electronic device control icon each configured to enable a user to command the mobile terminal to begin to determine the identifier of the electronic device.

19. The method of claim 11, wherein the step of determining comprises:
determining the identifier based on a matching of an image of the electronic device captured by the camera to an image or other data stored in the one of the memory and the remote server.

20. The method of claim 19, further comprising:
receiving the identifier from the electronic device in response to a request wirelessly transmitted from the mobile terminal to the electronic device after the matching of the image of the electronic device captured by the camera to the image or other data stored in the one of the memory and the remote server.
